(19) United States
(12) Patent Application Publication
(10) Pub. No.: US 2013/0170128 A1
(43) Pub. Date: Jul. 4, 2013

(54) MOTHERBOARD

(71) Applicants: DAN-DAN LIU, Shenzhen City (CN); JIA-QI DONG, Shenzhen City (CN); JI-CHAO LI, Shenzhen City (CN)

(72) Inventors: DAN-DAN LIU, Shenzhen City (CN); JIA-QI DONG, Shenzhen City (CN); JI-CHAO LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/400,770

(22) Filed: Feb. 21, 2012

(30) Foreign Application Priority Data
Dec. 29, 2011 (CN) 201110450657.4

(51) Int. Cl. G06F 1/16

(52) U.S. Cl. 361/679.32

(57) ABSTRACT

A motherboard includes a processor socket, a platform controller hub (PCH), a power circuit, a switch unit, and a memory slot. The PCH is connected to the memory slot and output a bus signal to a serial advanced technology attachment dual in-line memory module (SATA DIMM) when a SATA DIMM is inserted in the memory slot and when the switch unit is in a first state. When a memory module is in the memory slot the power circuit outputs a voltage to the memory module in response to a second state of the switch unit.

### CROSS-REFERENCE OF RELATED ART

Relevant subject matter is disclosed in a pending U.S. patent application with Application Ser. No. 13/221,916 filed on Aug. 31, 2011, with the same title “MOTHERBOARD”, which is assigned to the same assignee as this patent application.

### BACKGROUND

1. Technical Field

The present disclosure relates to a motherboard.

2. Description of Related Art

Many computing devices provide large storage capacities and large memory capacities. Depending on need, some users prefers computing devices having large storage capacity, others prefer the computer to have a large memory capacity. In general, a plurality of memory slots may be built into the motherboard of a computing device, to satisfy the requirements of users who want large memory capacities. However, for users who desire or prefer large storage capacities, some of the memory slots may not be occupied with memory modules. These unoccupied slots are useless for users not desiring large memory capacities and thus these extra memory slots are essentially wasting real estate on the motherboard. Therefore, there is room for improvement in the art.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments. Moreover, in the drawing, like reference numerals designate corresponding parts throughout the several views.

FIG. 1 is a circuit diagram of a motherboard in accordance with an exemplary embodiment.

FIG. 2 is an isometric view of the motherboard of FIG. 1 with a central processing unit (CPU) and a serial advanced technology attachment dual in-line memory module (SATA DIMM).

FIG. 3 is an isometric view of the motherboard of FIG. 1 with a CPU and a memory.

FIGS. 4 and 5 are schematic diagrams of the SATA DIMM module of FIG. 2.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

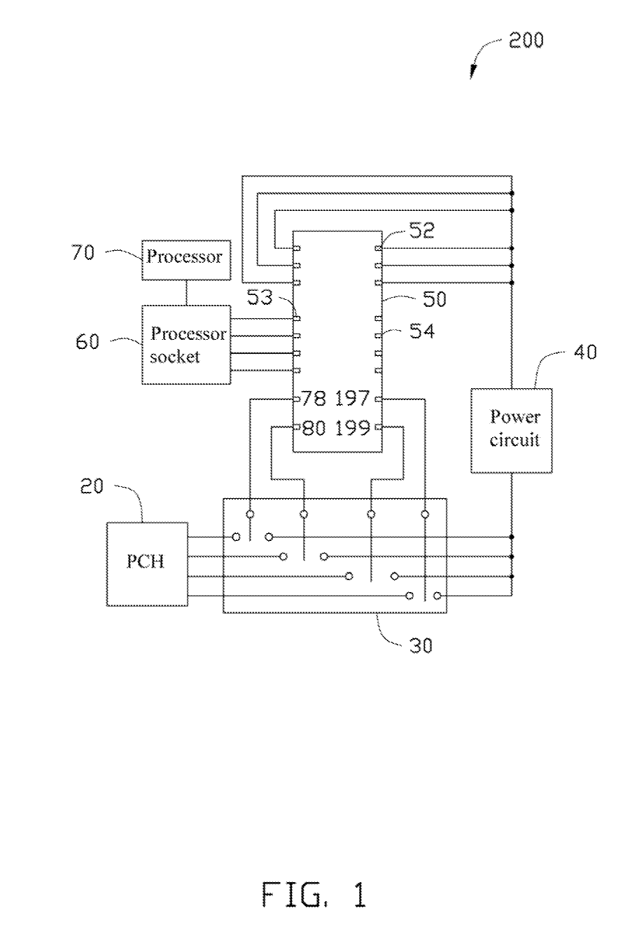

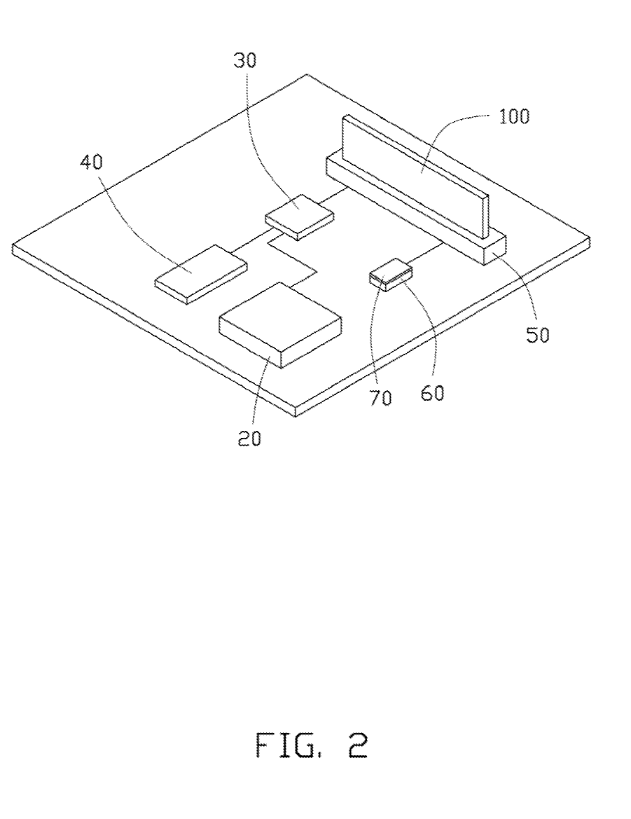

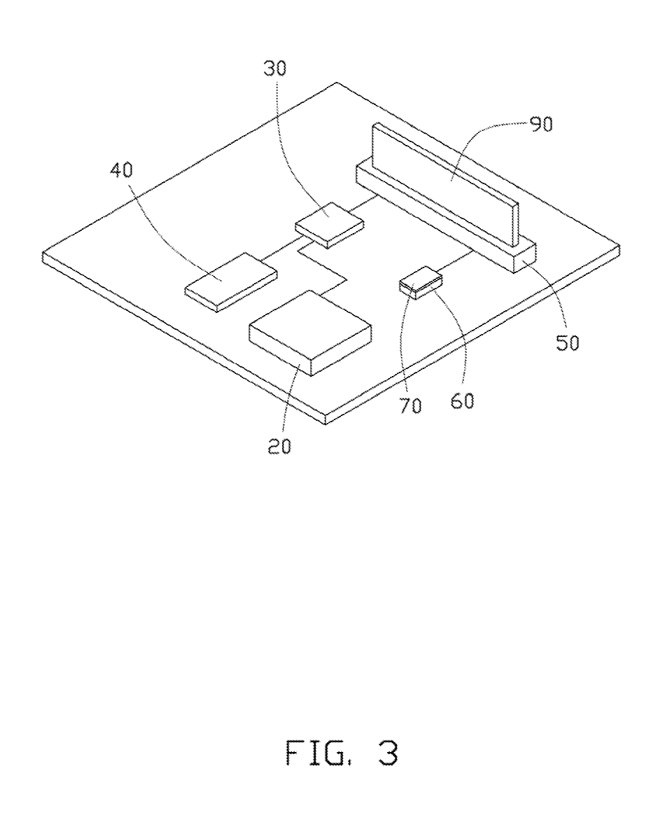

Referring to FIGS. 1 to 3, a motherboard 200 in accordance with an exemplary embodiment includes a platform controller hub (PCH) 20, a processor socket 60, a switch unit 30, a memory slot 50, and a power circuit 40. In one embodiment, all the other elements of the motherboard 200 are known elements of a generalized motherboard of a computer. In one embodiment, the memory slot 50 is a double data rate type two (DDR2) memory slot or a double data rate type three (DDR3) memory slot.

The memory slot 50 includes a plurality of power pins 52, a plurality of ground pins 54, a plurality of signal pins 53, and four input/output (I/O) pins, such as a pin 78, a pin 80, a pin 197, and a pin 199. The power pins 52 are connected to the power circuit 40, to receive voltage from the power circuit 40, and provide the voltage to a serial advanced technology attachment dual in-line memory module (SATA DIMM) 100 or a memory module 90, which is connected to the memory slot 50. The signal pins 53 are connected to the processor socket 60. The ground pins 54 are connected to a ground layer (not shown) of the motherboard 200. The input/output (I/O) pins are connected to the switch unit 30. The switch unit 30 is connected to the PCH 20 and the power circuit 40. When a SATA DIMM module 100 is mounted in the memory slot 50, the switch unit 30 is switched to a first state to connect the PCH 20 to the memory slot 50, the memory slot 50 receives a bus signal, such as a SATA signal from the PCH 20 through the switch unit 30 and receives a voltage from the power circuit 40, and provides the SATA signals and the voltage to the SATA DIMM module 100. When a memory module 90 is mounted in the memory slot 50, the switch unit 30 is switched to a second state to connect the power circuit 40 to the memory slot 50, the memory slot 50 receives a bus signal, such as a memory signal from a processor 70, which is mounted in the processor socket 60 and receives a voltage from the power circuit 40 through the switch unit 30, and provides the memory signal and the voltage to the memory module 90.

The switch unit 30 controls the memory slot 50 to be connected either to the power circuit 40 or to the PCH 20. When the switch unit 30 is in the first state, the pins 78, 80, 197, and 199 are connected to the PCH 20 through the switch unit 30, to connect the memory slot 50 to the PCH 20, to enable communication between the motherboard 200 and the SATA DIMM module 100 in the memory slot 50. When the switch unit 30 is in the second state, the pins 78, 80, 197, and 199 are connected to the power circuit 40, to connect the memory slot 50 to the power circuit 40, to enable communication between the motherboard 200 and the memory module 90, which is in the memory slot 50. In this embodiment a lever deployed on the switch unit 30 can be manipulated to control connection of the memory slot 50 to the PCH 20 or the power circuit 40 accordingly.

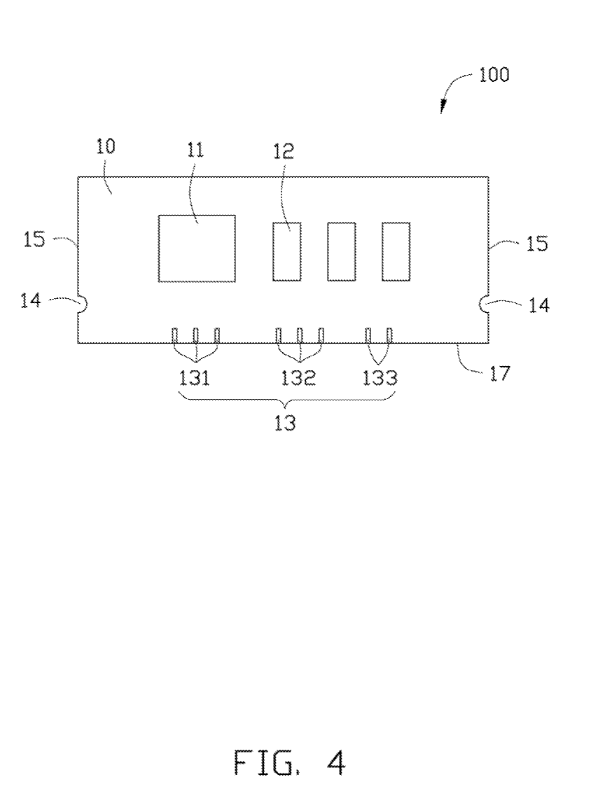

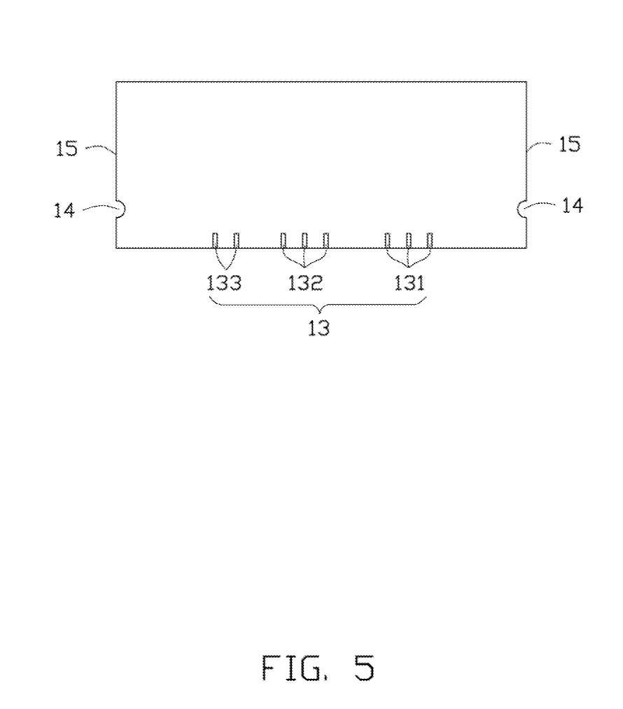

Referring to FIGS. 4 and 5, the SATA DIMM module 100 includes a substantially rectangular circuit board 10. A control chip 11 and a plurality of storage chips 12 are all arranged on the circuit board 10. An edge connector 13 is arranged on a bottom edge 17 of the circuit board 10, to be inserted into the memory slot 50. The edge connector 13 includes a plurality of power pins 131, a plurality of ground pins 132, and four signal pins 133 arranged on two opposite surfaces of the circuit board 10. The signal pins 133 include a pair of signal input pins and a pair of signal output pins. The power pins 131 are connected to the control chip 11 and the storage chips 12. The signal pins 133 are connected to the control chip 11. The ground pins 132 are connected to a ground layer (not shown) of the circuit board 10. Two grooves 14 are defined in two opposite ends 15 of the circuit board 10.

In use, when the SATA DIMM module 100 is inserted in the memory slot 50, the power pins 131 are connected to the power pins 52, and the signal pins 133 are connected to the pins 78, 80, 197, and 199. The power circuit 40 outputs a voltage to the SATA DIMM module 100 through the power pins 52 of the slot 50. The switch unit 30 is switched to the first state and controls the memory slot 50 to be connected to the PCH 20. The PCH 20 outputs a bus signal, such as a SATA signal to the SATA DIMM module 100 through the switch unit 30 and the pins 78, 80, 197, and 199 of the memory slot 50, to enable communication between the motherboard 200 and the SATA DIMM module 100.

When a memory module 90 is inserted in the memory slot 50, the switch unit 30 is switched to the second state and controls the memory slot 50 to be connected to the power circuit 40. The power circuit 40 outputs a voltage to the memory module 90 through the switch unit 30, the I/O pins of the memory slot 50, and the power pins 52 of the memory slot 50. The processor 70 mounted on the processor socket 60 outputs a bus signal, such as a memory signal to the memory module 90 through the signal pins 53, to enable communication between the motherboard 200 and the memory module 90.

The motherboard 200 can communicate either with a SATA DIMM module 100 or with a memory module 90 in the memory slot 50, through the control of the switch unit 30.

Even though numerous characteristics and advantages of the disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A motherboard comprising:
a processor socket to connect a processor;
a platform controller hub (PCH);
a power circuit;
a switch unit connected to the power circuit and the PCH; and
a memory slot comprising a plurality power pins connected to the power circuit for receiving a voltage, a plurality of ground pins, a plurality of signal pins connected to the processor socket, and four input/output (I/O) pins connected to the switch unit, wherein the memory slot is operable to connect either a serial advanced technology attachment dual in-line memory module (SATA DIMM) or a memory module;
wherein the PCH outputs a bus signal to the SATA DIMM module in response to the switch unit being at a first state, or the power circuit outputs a voltage to the memory in response to the switch unit being at a second state.

2. The motherboard of claim 1, wherein the memory slot is a double data rate type two memory slot or a double data rate type three memory slot.

3. The motherboard of claim 1, wherein the I/O pins of the memory slot are respectively pins 78, 80, 197, and 199.
